(19) United States
(12) Patent Application Publication
(10) Pub. No.: US 2002/0130076 A1
(43) Pub. Date: Sep. 19, 2002

(54) Aerated pond wastewater treatment system and process for controlling algae and ammonia

(76) Inventor: Clifford A. Merritt, (US)

Correspondence Address: OWENS-CORNING, FIBERGLAS CORP., 2790 COLUMBUS ROAD, ROUTE 16, GRANVILLE, OH, 43023, US

(21) Appl. No.: 09/739,029

(22) Filed: Dec. 13, 2000

Related U.S. Application Data
(63) Continuation of application No. PCT/US99/10139, filed on May 7, 1999.

(51) Int. Cl. C02F 3/10

(52) U.S. Cl. 210/615; 210/151

(57) ABSTRACT

A four-pond wastewater treatment process for controlling algae and ammonia in the effluent stream is disclosed. A plurality of opaque modular cover casings (80,81,82,83) are floated on some or all of the surface of the aeration pond, sedimentation pond, and polishing pond to block sunlight and thereby control algae growth and suspended solids. Attached growth biomedia is submerged in the aeration pond to enhance nitrification of ammonia.

### TECHNICAL FIELD AND INDUSTRIAL APPLICABILITY OF THE INVENTION

The present invention relates to the treatment of sanitary and non-sanitary wastewater for return to the environment. More particularly, the present invention relates to a four-pond wastewater treatment system and process in which biological oxygen demand, suspended solids, and ammonia in the effluent are controlled within acceptable limits. Suspended solids are controlled in part by limiting the growth of algae using an opaque modular floating cover on the surface of the aerated, sedimentation, and polishing ponds. Nitrification of ammonia is enhanced in the aerated pond using submerged attached growth biomedia for supporting nitrifier microorganisms below the modular cover.

### BACKGROUND OF THE INVENTION

In a wastewater treatment system, it was known to cover an aerated pond with a plurality of lashed together modular, floating foam cores each encased in a durable membrane for the purpose of blocking sunlight and inhibiting the growth of algae in the aerated pond. It was also known to provide such casings on the surface of a settling pond. Performance of such treatment systems was believed to result in biochemical oxygen demand of about 10 mg/l, suspended solids of about 10 mg/l, and ammonia of about 2 mg/l. It was believed that such sunlight blocking systems would allow for nitrification even in cold climates. Performance of systems employing the modular floating sunlight cover did not always meet expectations especially with respect to nitrification of ammonia in colder climates. By “colder climate,” I mean locations characterized by average ambient temperatures that are sufficiently low for at least a portion of the year that an ammonia discharge concentration of 2-10 mg/l, preferably 5-10 mg/l, is not substantially harmful to aquatic flora and fauna species populating said aquatic environment.

It was also known to submerge attached growth biomedia in aerated tanks to increase growth of nitrifying microorganisms. U.S. Pat. No. 5,399,266 to Hasegawa, for example, describes a wastewater treatment method using microbial media. The media including a central stay and polyvinylidene chloride fibers and acryl fibers in a 1:1 ratio woven into the stay removed more nitrogen from the wastewater than a similar medium including only polyvinylidene chloride fibers.

Furthermore, it was known to combine the use of submerged activated bio-web substrates in a light-transmitting, heat-retaining cover positioned above shade-providing natural macrophytes, such as duckweed, to control algae growth in an aerated tank. In the prior art system, the known problem of duckweed being blown to one side of an open pond or lagoon was solved by providing a greenhouse type enclosure for the wastewater treatment tank.

There remains a need for an outdoor wastewater treatment system and process for controlling algae growth and providing adequate nitrification in a colder climate. Surprisingly, Applicant has discovered that the combined use of sun-blocking covers and submerged biomedia in an outdoor pond wastewater treatment process provides unexpectedly superior performance with respect to removal of BOD, suspended solids, and ammonia.

### SUMMARY OF THE INVENTION

The invention is a process for treating sanitary and non-sanitary wastewater in a four-pond system in which wastewater feed flows, in order, through an aerated equalization pond, an aeration pond, a sedimentation pond, and a polishing pond. A plurality of floating modular casings lashed together cover substantially the entire surface of the aerated pond to block out sunlight and thereby significantly reduce if not prevent the growth of algae in the aeration pond. Pass-through openings in the cover accommodate preferably a pair of spaced-apart flotation style aerators. Preferably, the floating modular casings cover substantially all of the sedimentation pond and polishing pond, as well. To enhance the growth of nitrification microorganisms in the aeration pond, attached growth biomedia is submerged within the aeration pond.

### BRIEF DESCRIPTION OF THE FIGURES

FIG. 1 is a schematic of the four-pond wastewater treatment process of the present invention.

FIG. 2 is a perspective view of several prior art floating casings lashed together by fasteners and a fastening cable.

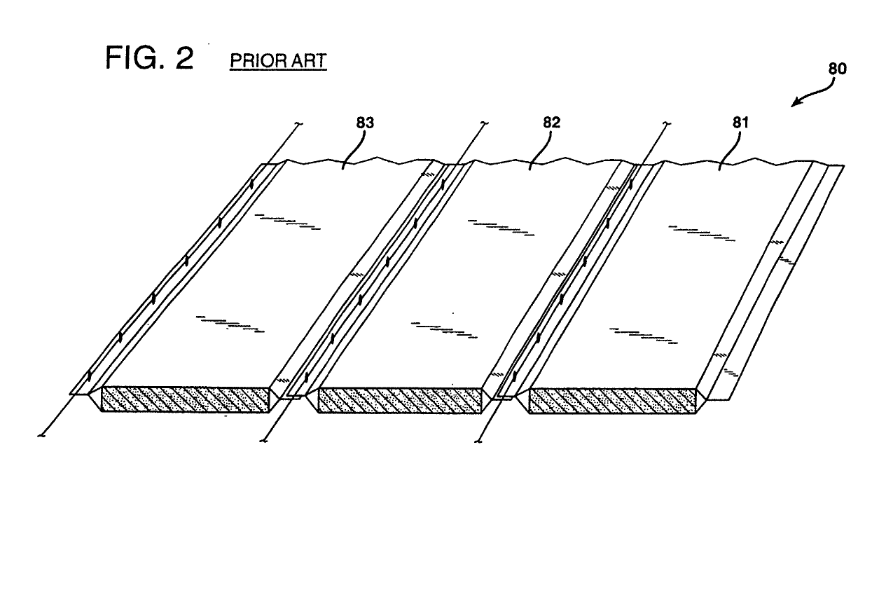

FIG. 3 is a detail elevation view of the prior art system of FIG. 2 for fastening floating casings together.

FIG. 4 is a perspective cutaway view of an alternative casing fastening system.

FIG. 5 is a diagram of a prior art biomedia.

### DETAILED DESCRIPTION AND PREFERRED EMBODIMENTS OF THE INVENTION

According to the process of the invention, raw wastewater 1 is treated in a four-pond wastewater treatment process for return to the environment. The raw wastewater may contain sanitary and non-sanitary or industrial components, such as cooling system blowdown and research laboratory chemical waste.

Solid matter in the raw wastewater is screened and optionally mechanically reduced in size using a conventional screened grinder 50. Wastewater feed 2 is fed first to the equalization pond 10 then to the aeration pond 20, sedimentation pond 30, and polishing pond 40 before it is discharged as process effluent 8 to a natural aquatic environment, such as a river.

Each of the treatment ponds (10, 20, 30, 40) will preferably have generally sloping sidewalls and a substantially flat central disposed pond bottom. Preferably, the ponds are clay-lined. While the shape of each pond is not critical, they will each be generally regular in shape. For example, the equalization pond, aeration pond, and sedimentation pond may be rectangular in shape while the polishing tank may be triangular in shape. The size and depth of each pond will be determined based on factors such as the nominal flow capacity of the system. The nominal flow capacity may be, for example, 0.15 MGD (million gallon per day). While the aeration, sedimentation, and polishing ponds are intended to maintain substantially constant liquid levels, it is intended that the equalization pond will vary in volume, from about 50,000 to about 120,000 gal. for accumulation and mixing of wastewater feed 2 so that perturbations in hydraulic load and variations in composition or biochemical oxygen demand (BOD) may be dampened to prevent these variations from affecting the aeration pond. The substantially flat central bottom 21 of the aeration pond may be approximately 30 ft×100 ft, for example, and have a nominal depth of 10 feet. Specific size or shape dimensions of the various ponds should not be viewed as limiting the scope of the claimed invention.

Both the equalization pond and aeration pond will include preferably a pair of spaced apart floating aerators 22, such as aspirating jet type aerators, placed generally above the diagonal corners of the substantially flat central pond bottoms.

Raw wastewater 1 may contain a sufficiently high level of chlorine, such as 0.05-0.1 mg/l or higher, as to at least inhibit if not prevent altogether the growth of the desired carbonaceous and nitrification microorganisms in the aeration pond. Accordingly, the equalization pond is dechlorinated, such as by the addition of sodium bisulfate, to reduce chlorine levels below the point at which microorganism growth in the aeration pond would be adversely affected. For example, the addition of sodium bisulfate 3 may be used to reduce the chlorine concentration in the equalization pond to 0.05 mg/l or less, preferably to about 0.01 mg/l or less. The dechlorinating agent may be added to the equalization pond in any convenient manner, such as by addition to the suction of the lift pump transferring wastewater from the equalization pond to the aeration pond with a portion of the pump discharge being recycled back to the equalization pond (not shown). The remaining portion of the lift pump discharge carries equalization pond effluent 4 to the aeration pond.

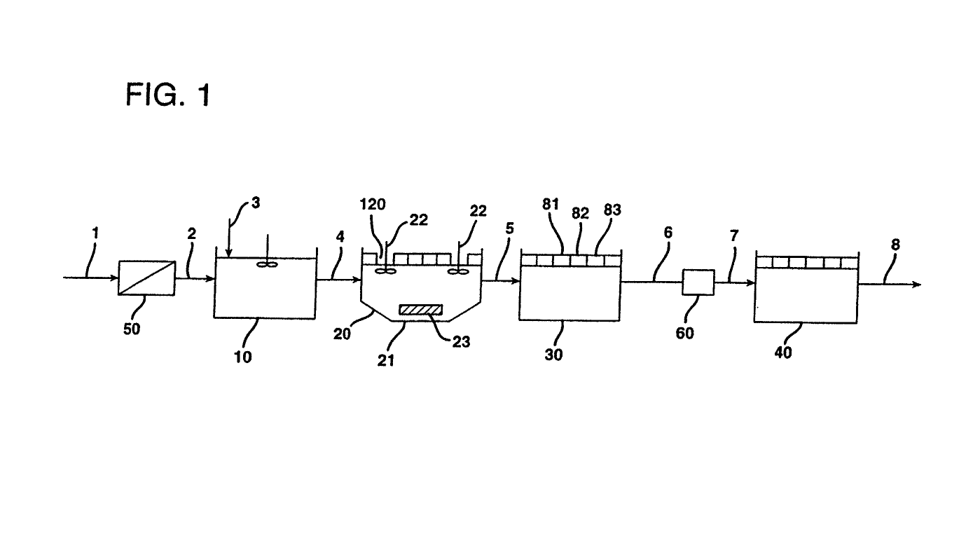

To enhance growth of nitrification bacteria in the aeration pond, one or more frames 23 supporting attached growth biomedia are placed on the central flat pond bottom 21 about mid-way between the aeration pond aerators. Preferably, the frames are made from an inert lightweight material, such as aluminum or polyvinyl chloride. The frames may be virtually any size, so long as the biomedia are submerged and not placed so close to the aerators to be disrupted or jostled by the hydraulic currents. For example, four 10 ft.×10 ft. aluminum frames may rest on a 30 ft×100 ft central bottom portion of the clay liner mid-way between two aerators positioned above two diagonal corners of the pond bottom. Aeration pond 20 is schematically shown in FIG. 1 which is not drawn to scale. Preferably, the frames have channels and foot pads for stability (not shown).

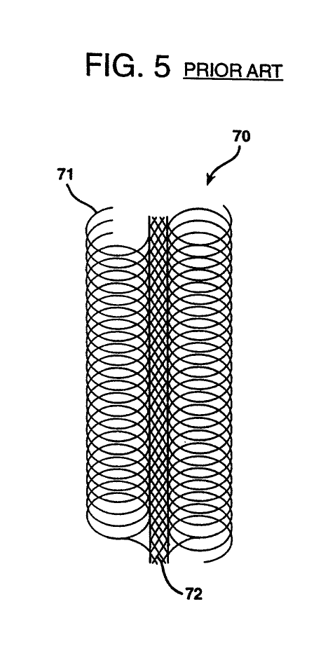

The frames support racks of attached growth biomedia. A variety of different types of biomedia are known, for example, batt media as described in U.S. Pat. No. 4,165,281. A preferred type is fiber loop type biomedia 70, as shown in FIG. 5, including fibers 71 attached to central strand 72. A most preferred type is RINGLACE™ brand attached growth biomedia, manufactured by Ringlace Products, Inc., Portland, Oreg. The RINGLACE™ biomedia is made of 100 micron diameter polyvinylidene chloride fibers woven into strands. The biomedia includes flexible loops extending from the strands. Nitrifier microorganisms are supported on the loops. The strands define an open spacing approximately three-inches across which allows for free-flow of oxygenated wastewater through the frames

The growth of algae is substantially reduced and virtually prevented altogether by blocking sunlight to one or more of the aeration. sedimentation, and polishing ponds. Preferably, sunlight is blocked from all three ponds. Any desired pond is deprived of natural sunlight by a number of possible means. Sunlight may be blocked by floating on its surface an opaque cover 80 assembled by lashing together a plurality of floating modular casings 81, 82, 83. The cover system is available from Industrial Environmental Concepts, Inc., of Minneapolis, Minn. Sunlight may also be blocked by semi-permeable fabrics suspended above the surface of the pond. Preferred fabrics will block and/or filter the sunlight by varying factors such as the weave, thread density, color, and polarization components. Thus, in a preferred embodiment, the means for shading the pond allows for regulation of the amount of shading by changing the cover or retracting the cover such that not all of the pond surface is covered.

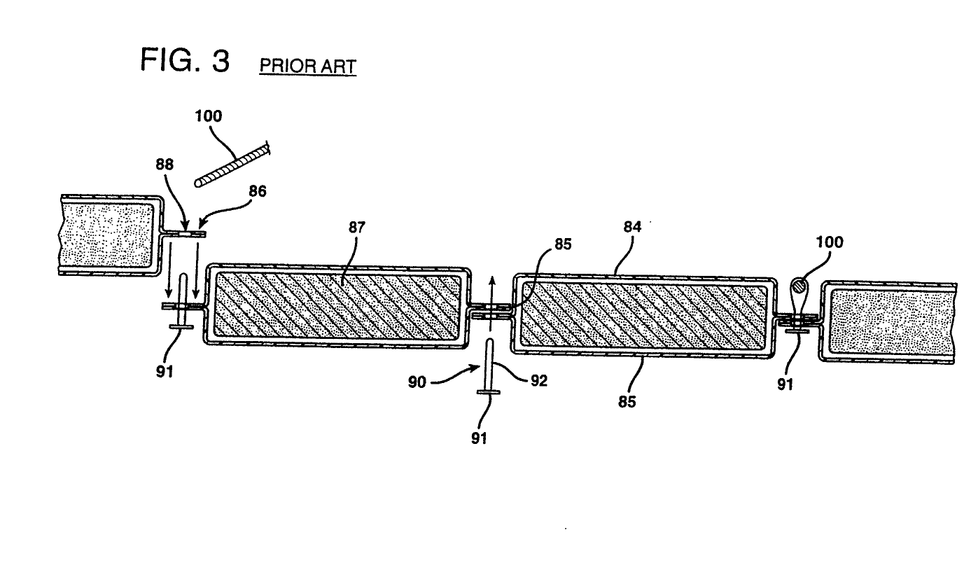

Each casing is generally rectangular in shape and up to about 8 feet wide and 40 feet long. As shown in FIG. 3, each casing is constructed from an upper membrane 84 and lower membrane 85 that is heat fusion welded together at a seam 85 along a casing edge 86. The upper and lower membranes sealingly encase a buoyant 2-inch thick foam core to provide floatation for the casing. Preferably, the foam is expanded polystyrene foam. The cores are most preferably FORMULAR®250 brand expanded polystyrene foam available from Owens Coming Corporation. The membranes are made from penetration-resistant 40-mil thick high density polyethylene.

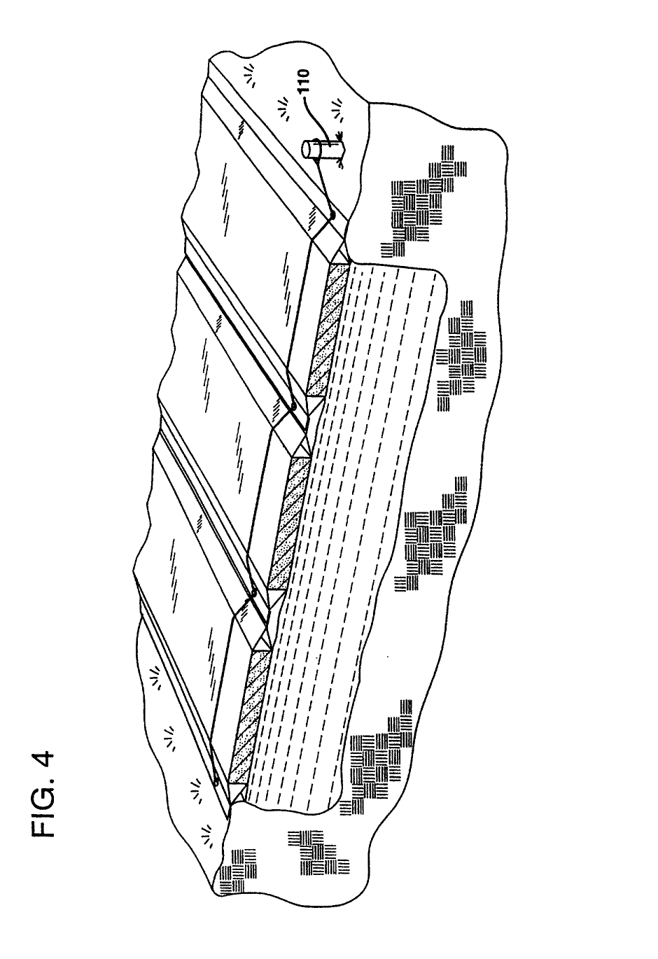

The casing edges 86 of adjacent casings overlie each other and are fastened together by a fastening system to form an overlap joint. Two such fastening systems arc shown in FIG. 3-FIG. 4. The fastening system in FIG. 3 includes a series of spaced-apart holes 88 along each peripheral edge of the casings. Upon vertical alignment of the edge holes of two adjacent casings, a fastening member 90 is inserted from underneath each pair of aligned holes until a band retaining member 91 on the fastening member 90 prevents further passage of the fastening member through the holes 88. Preferably, the fastening member includes a circular band 92 of membrane material at one end of which the retaining member is attached. For reasons that will become clear in the next paragraph, the retaining member 91 is designed to be pulled up against the underside of the overlapped casing edges 86 thereby preventing removal of the band entirely through the holes 88.

Once the bands are in place, a ¼-inch diameter polyvinyl chloride coated stainless steel cable 100 made from ⅛-inch diameter stainless steel aircraft cable (not shown separately) is threaded through the central opening in the bands. The cable is threaded through all bands in an aligned row of casing holes and anchored at each end by concrete fixtures 110 (see FIG. 4) beyond the perimeter of the pond. The cables allow the casings to rise and fall with minor changes in fluid level while securely holding down the casings in the wind.

The edge holes may be spaced at regular intervals, say, about 3 feet apart from one another. Each membrane edge is intentionally not otherwise securely attached to an adjacent membrane edge so that the pond surface may absorb oxygen and vent gasses through the overlap joints, rain water and snow melt may drain into the pond through the overlap joints, and water does not collect on the surface of the casings as to submerge the entire casings below the liquid surface. Accordingly, the pond can “breathe” through the overlapping joints.

The casings are substantially opaque to sunlight. The cover as a whole blocks substantially all light energy that would otherwise reach the pond surface during daylight hours. Hence, the floating modular cover significantly limits and preferably substantially prevents the growth of photosynthetic algae in the ponds equipped with the cover system.

By virtue of the thermal insulation R values for foam generally, and the preferred form of expanded polystyrene foam cores in particular, installation of such a floating cover on a pond is expected to considerably reduce heat loss from the pond to the environment especially during colder ambient weather conditions. The casings may have thermal insulation R values of 8-30 depending on the number of polystyrene cores encased by the membranes. Preferably, the casings may have an R value of 8-12 for at least partially thermally insulating the pond liquid from the ambient atmospheric conditions.

The aeration pond is aerated notwithstanding the presence of the floating cover covering preferably the entire pond surface. The cover may include pass-through openings 120 (FIG. 1) in the cover structure to accommodate placement of the floating aerators in the openings.

The process stream flows from the aeration pond to the sedimentation pond and then from the sedimentation pond to the polishing pond. One or preferably both of the sedimentation and polishing ponds also include a substantially opaque cover covering substantially the entire pond surface constructed from floating modular casings as described above with respect to the aeration pond. No pass-throughs are necessary, however, since the sedimentation and polishing ponds are not aerated.

In order to adequately control coliform bacteria, the polishing pond is disinfected by any suitable method. For example, chlorination of the polishing tank is one possible approach. Preferably, to reduce chlorine levels in the process effluent, the sedimentation pond effluent is irradiated by an artificial source of ultraviolet radiation 60 to such an extent as to effectively disinfect the polishing tank effluent 8.

The polishing pond effluent is discharged to an aquatic environment such as a stream, river, marsh, pond, bay, ocean, or other natural body. The present invention is especially well suited and beneficial for use in colder climates. Colder climates include locations characterized by average ambient temperatures that are sufficiently low for at least a portion of the year that an ammonia discharge concentration of 2-10 mg/l, preferably 5-10 mg/l is not substantially harmful to aquatic flora and fauna species populating said aquatic environment.

The process of the present invention effectively reduces effluent concentrations to within acceptable limits. Biochemical oxygen demand can be reduced to below about 10 mg/l, preferably below about 5 mg/l, and more preferably to about 3 mg/l. Suspended solids may be reduced below about 12 mg/l, preferably below about 10 mg/l, and more preferably below about 6 mg/l. Ammonia can be reduced to below about 2 mg/l, preferably about 1 mg/l, and more preferably below about 1 mg/l. pH can be controlled in the range of about 6.5 to about 9, preferably in the range of about 7 to about 8.5, and more preferably in the range of about 7 to about 8, without the addition of neutralizing agents such as carbon dioxide or strong acids to the wastewater being processed. Chlorine can be controlled below about 0.02 mg/l and preferably below about 0.01 mg/l.

As shown by the following example, the result of the present invention is a wastewater treatment process discharge stream having unexpectedly improved performance characteristics.

### EXAMPLE I

A four-pond wastewater treatment facility rated for 0.15 MGD wastewater flowrate was constructed. Floating modular covers were installed on the sedimentation pond and polishing pond, but not on the aeration pond or equalization pond. Submerged attached growth biomedia was not used. Dechlorination of the equalization pond was conducted. The wastewater flow rate was about 0.08 MGD, and the process effluent was characterized as reported in Table I. In Table I, “SS” refers to “suspended solids.”

### EXAMPLE II

The same conditions as stated in Example I, except attached growth biomedia was submerged in the aeration pond as described above. The wastewater flow rate was about 0.04 MGD, and the process effluent was characterized as reported in Table I.

### EXAMPLE III

The same conditions as in Example II, but floating modular covers were also installed on the aeration pond. The wastewater flow rate was about 0.04 MGD, and the process effluent was characterized as reported in Table I.

TABLE I

| | Example 1 | Example II | Example III |
|---|---|---|---|
| Time of year | Early Fall | Early Fall | Early Spring |
| Ponds Covered | Sedimentation & | Sedimentation & | Aeration, |
| | Polishing | Polishing | Sedimentation, |
| | | | Polishing |
| Pond with | None | Aeration | Aeration |
| Biomedia | | | |
| Flow, MGD | 0.08 | 0.04 | 0.04 |
| BOD, mg/l | 3.8 | 2.8 | 4.3 |
| SS, mg/l | 4.5 | 4.0 | 6.0 |
| Ammonia, mg/l | 3.0 | 1.0 | 1.0 |

The foregoing examples are provided for purpose of illustration only, and are in no way meant to limit the scope of the invention defined by the claims which follow.

What is claimed is:

1. A wastewater treatment process comprising:
feeding a wastewater process stream to an aerated pond;
exposing said process stream to biomedia submerged in said aerated pond;
providing shade to at least a portion of said aerated pond to such an extent as to substantially inhibit growth of algae in said aerated pond.

2. The process of claim 1 wherein said shade is provided by non-living matter.

3. The process of claim 2 wherein said non-living matter comprises a plurality of floating modules shaped sufficiently regularly as to permit ordered coverage of substantially the entire liquid surface of said pond.

4. The process of claim 3 wherein each of said modules comprises a casing having a floatation core encased in a membrane material, said membrane material defining an edge along which a fastener system is capable of lashing adjacent casings together to effect resistance to wind forces.

5. The process of claim 1 wherein the step of shading is effective to reduce suspended solids from said process to less than about 10 mg/l.

6. The step of claim 1 wherein said biomedia supports nitrification microorganisms.

7. The step of claim 6 wherein said biomedia is supported by a structure submerged in said pond so as to substantially immobilize said biomedia.

8. The process of claim 7 wherein said submerged structure is positioned within said aerated pond as to minimize hydraulic forces or currents acting on said microorganisms.

9. The process of claim 1 wherein said biomedia includes a plurality of fibers on which microorganisms may be supported and said fibers are made from only one composition of matter.

10. The process of claim 9 wherein said composition is polyvinylidene chloride.

11. The process of claim 10 wherein said biomedia is RINGLACE™ brand attached growth biomedia.

12. The process of claim 1 further comprising the steps of feeding the aerated pond effluent to a sedimentation pond, feeding the sedimentation pond effluent to a polishing pond, and providing shade to at least a portion of each of said sedimentation pond and polishing pond to substantially prevent growth of algae in any of said aerated, sedimentation, and polishing ponds.

13. A wastewater treatment apparatus comprising:
an aerated pond;
non-living floating means for providing shade in said aerated pond; and
biomedia submerged in said aerated pond.
